(19) United States
(12) Patent Application Publication
(10) Pub. No.: US 2005/0087904 A1
(43) Pub. Date: Apr. 28, 2005

(54) Manufacture of extruded synthetic wood structural materials

(76) Inventor: Robert J. Bryan, Etobicoke (CA)

Correspondence Address: KEYSER MASON BALL, LLP, FOUR ROBERT SPECK PARKWAY, SUITE 1600, MISSISSAUGA,, ON, L4Z 1S1, CA

(21) Appl. No.: 10/691,490

(22) Filed: Oct. 24, 2003

(51) Int. Cl. B29C 47/00; B29C 47/38; B29C 47/60

(52) U.S. Cl. 264/148; 264/211; 264/211.23; 264/211.21

(57) ABSTRACT

Extruded synthetic wood structural material comprises at wood fiber, plastic, and a coloring agent. In its manufacture, finely divided wood fiber having an initial moisture content of 0.5% to 20%, and a coloring agent, are placed together and fed to a heated mixer. Water vapor is driven off. The plastic resin is added to the mixture, which is then forced through an extrusion die, cooled, and cut to length. The resulting extruded material is homogeneously colored, and has zero or very low water content. The extruded synthetic wood structural material comprises from 20% to 60% by weight of wood fiber content, from 20% to 60% by weight of plastic resin content, and from 0.5% to 5.0% by weight of coloring agent.

### FIELD OF THE INVENTION

This invention relates to extruded synthetic wood structural materials, and particularly relates to such extruded synthetic wood structural materials which are colored and which have colorfast properties. The extruded synthetic wood structural materials of the present invention comprise wood fiber and plastic resin as their principal components, together with coloring agent. The present invention provides a method for manufacture of such extruded synthetic wood structural materials.

### BACKGROUND OF THE INVENTION

Fabricated, synthetic wood materials are well known, as will be briefly discussed hereafter during a discussion of the Prior Art. However, it is a failing of all such prior art synthetic wood materials, particularly those that are employed as structural materials for such purposes is decking, railings, siding, etc., that they demonstrate a tendency to fade, sometimes quite quickly, and not uniformly.

There is a well demonstrated requirement in the market for structural materials that exhibit the appearance, feel, and handling characteristics of real wood. That is, there is a requirement in the market for synthetic wood structural materials that can be cut and sawn, have nails and screws driven into them, and so on. However, the market generally demands such synthetic wood structural materials to be already colored, so as to preclude the necessity for them to be painted. Indeed, the materials which comprise synthetic wood structural materials may very often not be susceptible to being painted.

Moreover, there is presently a growing concern for the preservation of forest resources; and at the same time, there is a decreasing available supply of good quality wood that can be used for such purposes as decking and railings, siding, etc. This is not to say that there is not a considerable demand for real wood which finds extensive use in framing housing construction, flooring and trimming, etc., and indeed it is the fact that there is still considerable demand for the use of real wood which provides one of the principal raw ingredients of the synthetic wood structural materials of the present invention, namely, the wood constituent.

An alternative to the use of wood planking is the use of particle board. Indeed, in the furniture industry, composite board—which comprises sawdust and resin as the principal components—is very often employed, over which a veneer is placed. However, the purpose of the present invention is more directed to structural purposes for structures that will be primarily built outdoors, but which are ancillary to principal structures such as housing, and so on. The extruded synthetic wood structural materials as they are manufactured in keeping with the present invention, and which therefore have a color already as they come off the manufacturing line, therefore provide structural materials that may be used for decking and siding, as well as railings and the like, on homes and cottages, as boat decks on waterways, etc. Such structures require little or no maintenance, they do not need to be painted or stained, and they are not subject to deterioration such as splintering and the like. However, the prior a new well rt materials that have been employed hitherto have all demonstrated a lack of color fastness, and have been subject to fading and streaking in a manner which is not visually acceptable.

Prior art synthetic wood replacement materials have been generally produced by extruding a combination of a thermoplastic material and a fibrous wood material using commercially available, well known extruders. The prior art synthetic wood replacement materials have typically included dyes or pigments for coloring, and/or other various coloring agents and fillers. However, in the prior art production of synthetic wood replacement materials, the coloring or pigmentation is added to the resin which is one of the principal components of the synthetic wood replacement materials.

It should be noted that wood fiber as may be employed in keeping with the present invention, and as it has been employed in the prior art, typically has between 3% and 10% by weight of water. The thinking and the practice in the prior art has been always to remove the moisture from the wood fiber prior to it being fed into the extrusion process. Of course, it is well recognized that the moisture must be removed from the wood fiber so as to preclude the creation of voids in the finished product, and so as to assure its homogeneity and structural integrity. Even if the moisture has been driven off from the wood fiber in the initial stages of an extrusion process in the prior art, it is not until later in the process, and typically at the same time as the resin is introduced, that color or pigmentation is added to the mixture. As noted, typically the resin is pre-colored in prior art processes.

The extrusion process per se is well known. Typically, a single screw pump is employed to pump or force a molten mixture of wood fiber, plastic resin, and other additives including color pigmentation, through an extrusion die. The extrusion die may comprise one or several plates, but the details of the single screw pump and the extrusion die, and indeed of the specific manufacturing apparatus as it is employed in the present invention, are beyond the scope of the present invention and/or are well known to those skilled in the art, except as noted hereafter.

A principal purpose of the present invention is to provide extruded synthetic wood structural materials which are colorfast, and which have no tendency to fade, particularly when exposed to sunlight. The inventor herein has unexpectedly discovered that this goal may be achieved primarily by admixing finely divided wood fiber and a coloring agent prior to any other step, and heating that mixture so as to drive off water vapor and to attain a stable wood fiber/coloring agent mixture.

Thereafter, resin is added to the mixture, which is heated so as to become a molten, homogenous mixture, and which may thereafter be extruded in keeping with known techniques therefor.

Without being bound by theory, it is postulated that as moisture is driven off from the moist wood fiber, as water vapor, the structural space which was previously occupied by the water molecules is, at least in part, replaced by the coloring agent—which may be in the form of pigment or pellet—so that an interstitial physical mixture of wood fiber and the coloring agent occurs. Thereafter, when the plastic resin is introduced to that mixture at elevated temperatures whereby the plastic resin is molten, at least a portion of the coloring agent migrates to and is dissolved by or forms an homogenous mixture with the plastic resin, whereby the entire structure is evenly and homogeneously colored.

### DESCRIPTION OF THE PRIOR ART

Collins et al U.S. Pat. No. 3,908,902 teaches extruded synthetic railroad ties, beams, and structural members which comprise a waste wood, aluminum hydrate, and a polyester resin, together with appropriate catalysts. The waste wood products, however, are very coarse, typically having a minimum dimension of 0.25 in.

Matejka et al U.S. Pat. No. 4,517,228 teaches a pigmented prepress coating that is employed to form a composition board that has a smooth or embossed or textured surface. The coating includes a mixture of an acrylic, hydroxyl, or carboxylic function vehicle, together with a melamine-based coating cross-linking agent, and a platelet form of talc. The purpose is to preclude discoloration of the composite board's surface.

Layer U.S. Pat. No. 5,516,472 teaches an extruded synthetic wood composition, and is particularly directed to a method for producing the same. Here, a transition die and a stranding die are employed prior to a molding die. The material is preformed through the transition die more or less to the shape of the finished product, it is then stranded to form individual strands, and it is then compressed in the molding die.

Bednar et al U.S. Pat. No. 5,539,028 is concerned with a water-resistant fiberboard and a process for making it. Here, the product is produced in panels or tiles and includes silicone fluid additives so as to improve the water resistance of the manufactured product.

Brandt et al U.S. Pat. No. 5,827,462 relates to a method for manufacturing a coextruded synthetic wood product, and is particularly concerned with the process of cooling the extruded product after it has been extruded.

Ronden et al U.S. Pat. No. 5,981,631 teach a process whereby composites of co-mingled thermoset resin bonded wood waste are blended with thermoplastic polymers. A coupling agent is employed which comprises at least one fatty acid having at least 16 carbon atoms and at least one rosin acid also having at least 16 carbon atoms.

Zehner U.S. Pat. Nos. 6,011,091, 6,103,791, and 6,248,813 (the latter patents being successive continuations of the former patents), are each concerned with a vinyl based cellulose reinforced composite wherein the cellulosic material comprises about 50% to about 75% by weight of the composite, and there is at least one polyvinyl chloride material in the range of about 25% to about 50% by weight of the composite, together with at least one polar thermosetting material in the range of from about 0% to about 4% by weight of the composite.

A further United States patent issued to Brandt is 6,117,924, and that patent teaches an extrusion process for synthetic wood material where the material is compressed in the die system to a ratio of at least about 2 to 1, so as to form a final shape and a final cross-sectional area.

Suwanda U.S. Pat. No. 6,210,616 is also related to an extrusion process for thermoplastic composites having a high filler content. Here, the composite comprises 20% to 60% of a thermoplastic resin, and 40% to 60% by weight of a filler which is cellulose based.

### SUMMARY OF THE INVENTION

The present invention provides a method manufacture of an extruded synthetic wood structural material which comprises at least a wood fiber content, a plastic resin content, and a coloring agent, and is carried out by following the steps of:
(a) Placing together finely divided wood fiber and a coloring agent.
(b) Feeding the wood fiber and the coloring agent to a heated mixer to thoroughly mix the wood fiber and the coloring agent, and so as to drive water vapor away from the wood fiber.
(c) Adding and thoroughly mixing the plastic resin content to the thoroughly mixed wood fiber and coloring agent, while continuing to heat the same.
(d) Transferring the thoroughly mixed plastic resin, wood fiber, and coloring agent mixture to an extrusion die and forcing the mixture through the extrusion die.
(e) Cooling and hardening the extruded mixture, and cutting to length the so-formed extruded synthetic wood structural material.

Typically, the wood fiber content initially has a moisture content of from 0.5% up to 20% by weight thereof.

The extruded synthetic wood structural material is colored by the coloring agent, and has a moisture content of zero up to about 0.1% by weight thereof.

Also, the extruded synthetic wood structural material comprises from 20% to 60% by weight of wood fiber content, from 20% to 60% by weight of plastic resin content, and from 0.5% to 5.0% by weight of coloring agent.

According to one provision of the present invention, the finely divided wood fiber and the coloring agent may be coarsely mixed together and stored in a location remote from the heated mixer.

More usually, however, the finely divided wood fiber and the coloring agent are coarsely mixed together just prior to step (b), in a location adjacent the heated mixer.

Typically, the finely divided wood fiber is wood flour.

In general, the heated mixer is a twin screw mixer having a heated jacket and at least one vent for the water vapor as it is driven off. The heated jacket is heated to a temperature of from 120° C. to 235° C.

Broadly speaking, the wood fiber content may be chosen from the group consisting of sawdust, finely divided wood chips, ground wood, wood meal, wood flour, finely divided wood flakes, finely divided coconut shells, finely divided peanut shells, palm fiber, bamboo fiber, rice hulls, wheat pulp, finely divided straw, and mixtures and combinations thereof.

Moreover, the plastic resin content may be chosen from the group consisting of polyethylene, polypropylene, polyvinyl chloride, low-density polyethylene, ethyl-vinyl acetate, and mixtures and combinations thereof.

Further, the coloring agent may be chosen from the group consisting of color pellets, color pigments, and mixtures and combinations thereof.

Typically, step (d) is carried out at least in part by pumping the thoroughly mixed plastic resin, wood fiber, and coloring agent, through a single screw pump, so as to force the mixture through the extrusion die.

If so, then typically the single screw pump has a heated jacket so as to keep the mixture in a substantially molten state.

In keeping with another provision of the present invention, the formulation of the extruded synthetic wood structural material may further comprise at least one additive chosen from the group consisting of a lubricant in the amount of 1% to 10% by weight, a strengthening agent in the amount of 1% to 30% by weight, a fungicide in the amount of 0.1% to 5% by weight, a UV inhibitor in the amount of 0.1% to 5% by weight, and mixtures and combinations thereof.

If so, then typically the at least one additive is added to the formulation between step (b) and step (c).

### BRIEF DESCRIPTION OF THE DRAWINGS

The novel features which are believed to be characteristic of the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 is a schematic showing the apparatus on which the method in keeping with the present invention is carried out.

### DETAILED DESCRIPTION OF THE PREFERRED EMBODIMENTS

The novel features which are believed to be characteristic of the present invention, as to its structure, organization, use and method of operation, together with further objectives and advantages thereof, will be better understood from the following discussion.

It has previously been noted that the principal purpose of the present invention is to provide an extruded synthetic wood structural material which has an appearance that is similar to wood and which may be employed in much the same circumstances as wood for purposes such as decking, siding, railings, etc. Other prospective purposes to which the structural materials of the present invention may be put include use as window and door framing or moldings, roofing systems, and possibly even casual furniture, where the purposes to which the extruded synthetic wood structural materials are put do not exceed the structural capabilities of the material. It has also been noted that the extruded synthetic wood structural materials provided by the present invention are colored, and are colorfast.

It will be understood that a skilled artisan, and/or a person skilled in the extrusion arts, it is possible to employ techniques whereby surface features of extruded synthetic wood structural materials in keeping with the present invention may be provided so as to emulate various wood grains and the like; and the purposes for which the extruded synthetic wood structural materials may be put may be considerably different than those which have been suggested or discussed above.

It will also be understood that certain aspects concerning the extrusion process, and the employment of extrudable thermoplastic resins, are beyond the scope of the present invention in that they will fall within the knowledge commonly held by the skilled artisan. It will also be evident to the skilled artisan that the thermoplastic resin that is employed may have other optionally mixed additives such as flow control agents, flame retardants, cross-linking agents, accelerators, inhibitors, enhancers, fillers, lubricants, desiccants, fungicides, insecticides, blowing agents, and the like.

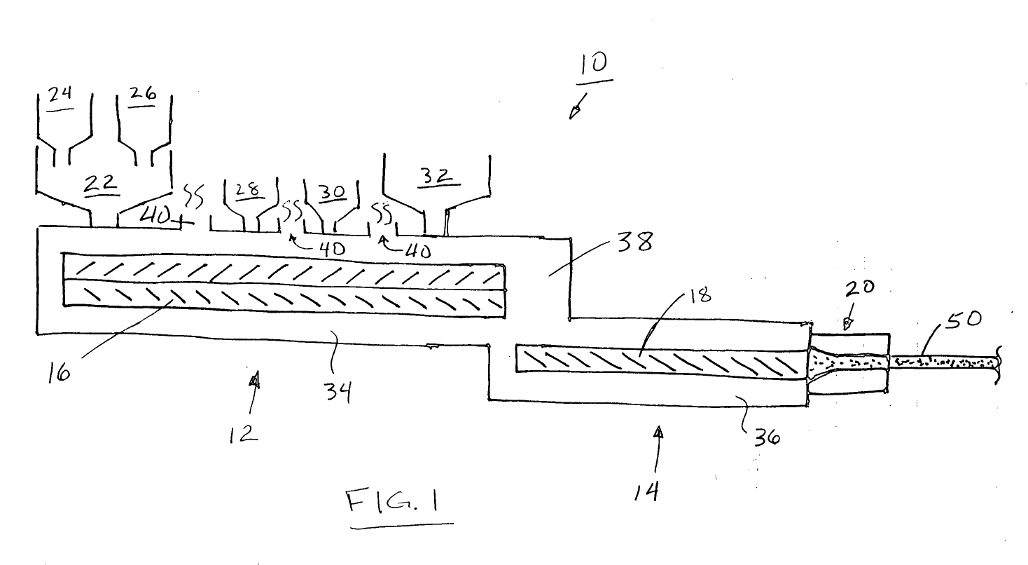

Referring to FIG. 1, a number of the principal features of an extrusion line upon which the method of the present invention may be carried out, are now discussed. The extrusion line in its entirety is indicated by the numeral 10, and comprises as its two principal components a twin screw mixer portion 12 and a single screw pump portion 14, at the end of which there is placed an extrusion die 20. The extruded product is shown at 50, and after it leaves the extrusion die 20, the extruded product 50 is passed through sizing dies and cooling baths and/or tunnels in the manner that is well known to the skilled artisan.

What is important to note is that the twin screw mixer section 12 employs twin screws 16 which are surrounded by a heating jacket 34 in which one or a plurality of vents 40 are located for purposes described hereafter. Likewise, the single screw pump section 14 employs a single screw 18 which is surrounded by a heating jacket 36. The heating jackets 34 and 36 are heated to temperatures that are appropriate to the thermoplastic resin being employed so as to maintain the mixture as described hereafter in a molten state. However, as noted hereafter, typically the heated jacket 34 of the twin screw mixer section 12 is heated to a temperature of from 120° C. up to 235° C. so as to drive off the moisture content of the wood fiber content of the mixture from which the extruded synthetic wood structural material will be derived.

Typically, the elevations of the twin screw mixer section 12 and the single screw pump section 14 are different, with the twin screw mixer section 12 being higher than the single screw pump section 14. Thus, a transition section 38 is employed to transfer the molten mixture as it exits the twin screws 16 to the single screw 18.

The various constituents which comprise the mixture from which the extruded synthetic wood structural material of the present invention is derived are added to the twin screw mixer section at different locations along its length. The first components that are added are added through inlet 22, which in turn has inlets 24 and 26 that feed finely divided wood fiber and a coloring agent into the twin screw mixer section 12. Other additives may optionally be added at inlets 28 and 30, as described hereafter; and the other principal component of the mixture, namely the plastic resin, is added at inlet 32.

To reiterate the principal steps of the method in keeping with present invention, they are as follows:
(a) Placing together finely divided wood fiber and a coloring agent.
(b) Feeding the wood fiber and the coloring agent to a heated mixer to thoroughly mix the wood fiber and the coloring agent, and so as to drive water vapor away from the wood fiber.
(c) Adding and thoroughly mixing the plastic resin content to the thoroughly mixed wood fiber and coloring agent, while continuing to heat the same.
(d) Transferring the thoroughly mixed plastic resin, wood fiber, and coloring agent mixture to an extrusion die and forcing the mixture through the extrusion die.
(e) Cooling and hardening the extruded mixture, and cutting to length the so-formed extruded synthetic wood structural material.

Thus, it will be to the understood that the finely divided wood fiber and the coloring agent are placed together so as to be fed to the mixer 12 at inlet 22. It will be understood, however, that the finely divided wood fiber and the coloring agent may be placed together and coarsely mixed at a location which is remote from the twin screw mixer section 12, so that inlets 24 and 26 may exist elsewhere. However, the finely divided wood fiber and the coloring agent are, in any event, introduced into the mixer 12 at its outer end.

It is well known that the mixing operation in a twin screw mixer is such that a very thorough mix is achieved, so that by the time the finely divided wood fiber and the coloring agent has passed along at least a portion of the length of the mixer 12, they are thoroughly mixed. However, it has been noted that the mixer 12 includes a heated jacket 34. That jacket is heated so as to drive off the water vapor from the moisture content that the finely divided wood fiber initially has. The water vapor is driven off through the vent or vents 40. The presumed theory of the migration of the coloring agent into interstitial relationship with the finely divided wood fiber has been briefly discussed above.

The next important step in the process is to add to thoroughly mix the plastic resin content to the already thoroughly mixed wood fiber and coloring agent. This is done at the inlet 32; and it is noted that the mixture continues to remain heated particularly so as to melt the plastic resin, and once melted so as to maintain the mixture in a molten state. Once again, the presumed theory is that at least a portion of the coloring agent leaves is in an interstitial relationship with finely divided wood fiber, and goes either into solution or into suspension in the molten plastic resin. In any event, the coloring agent is widely and evenly dispersed throughout the finely divided wood fiber and the thermoplastic resin content of the mixture.

Following the thorough mixture of the plastic resin with the finely divided wood fiber and the coloring agent, the then thoroughly mixed mixture is transferred by the transition section 38 towards the extrusion die 20. The mixture is forced through the extrusion die as a consequence of the action of the single screw pump 14. Once again, the specific details of the extrusion die 20 are beyond the scope of the present invention, but are well known to the skilled artisan.

After the extruded product 50 leaves the extrusion die 20, it is cooled and hardened and then cut to length so as to form individual pieces of extruded synthetic wood structural material which may then be employed in a variety of manners, as described above.

It is important to note that the wood fiber content which is employed in keeping with present invention will initially have a moisture content of from 0.5% to 20% by weight thereof. However, moisture contents above 10% are rare; and moisture contents below 1% are rarer still. In any event, in keeping with the presumed theory of the present invention, as described above, it is important that there must be moisture content in the finely divided wood fiber as it is first admixed with the coloring agent in order for the coloring agent to interstitially displace at least some of the water vapor entrained in the finely divided wood fiber.

It will now be understood, of course, that the extruded synthetic wood structural material as it is produced in keeping with the present invention is colored by the coloring agent. It will also be understood that the extruded synthetic wood structural material will typically have a moisture content of zero; however, there may remain some interstitially entrained moisture such that a very little moisture content of perhaps up to about 0.1% may remain, without materially affecting the structural characteristics of the extruded synthetic wood structural material.

The basic formulation of the extruded synthetic wood structural material in keeping with present invention is as follows:

| | |
|---|---|
| Wood fiber content | from 20% to 60% by weight |
| Thermoplastic resin content | from 20% to 60% by weight |
| Coloring agent | from 0.5% to 5.0% by weight |

Typically, the finely divided wood fiber is wood flour. However, the fact is that the finely divided wood fiber content may be derived from other cellulosic wood sources, such as sawdust, finely divided wood chips, ground wood, wood meal, wood flour, finely divided wood flakes, finely divided coconut shells, finely divided peanut shells, palm fiber, bamboo fiber, rice hulls, wheat pulp, finely divided straw, and mixtures and combinations thereof.

Moreover, the plastic resin content is typically polyethylene, but it may also be derived from polypropylene, polyvinyl chloride, low-density polyethylene, ethyl-vinyl acetate, and mixtures and combinations thereof.

The coloring agent may be color pellets or color pigments, or mixtures and combinations thereof. Typically, the coloring agent is a finely divided color pigment powder.

The formulation of the extruded synthetic wood structural material in keeping with present invention may comprise several optional or desirable additives, depending on the purpose to which the synthetic wood structural material will be put, and depending on the precise details of the machinery of the extrusion line. For example, additional additives may include a lubricant in the amount of 1% to 10% by weight, a strengthening agent in the amount of 1% to 30% by weight, a fungicide in the amount of 0.1% to 5% by weight, a UV inhibitor in the amount of 0.1% to 5% by weight, and mixtures and combinations thereof.

If so, then the additional additives will generally be added to the formulation at inlets 28 and/or 30, and in the process as described above between steps (b) and (c).

It will be understood that the numerical ranges as described and discussed herein are not so specific that a small variation at either end of the stated range is not possible or permissible.

Planking materials were manufactured in keeping with present invention, and a second control lot of planking materials were manufactured also in keeping with the method steps described above except that the coloring agent was added to the plastic resin and thus entered the mixture after a significant portion if not all of the initial moisture content of the finely divided wood fiber had already been driven off.

Samples of both the planking materials in keeping with the present invention and the control lot as described immediately above were placed into the sunlight out of doors in the southeastern part of Florida for a period of more than one year. The planking materials in keeping with present invention exhibited virtually no fading, particularly when compared with the planking materials from the control lot. Other groups of planking materials were taken from the test production of planking materials in keeping with present invention and from the control lot, and were placed in storage for a period of one year. Once again, while the fading of the samples from the control lot was less profound then the fading that occurred in the samples from the same control lot which were placed out of doors in the sunlight in Florida, nonetheless fading did occur with those samples, especially as compared to the samples that were prepared in keeping with the present invention.

Thus, it has been demonstrated that extruded synthetic wood structural materials in keeping with present invention exhibit considerable resistance to fading either when exposed to sunlight and the elements, or in storage. In other words, the extruded synthetic wood structural materials in keeping with present invention exhibit colorfastness, and are therefore considerably more attractive for use in long-term structures.

There has been described a method for manufacturing extruded synthetic wood structural materials in keeping with present invention, and that description has been made in association with a schematic representation of typical extruding equipment of the sort known to the skilled artisan. Other features and principles in keeping with present invention may be derived or otherwise arrived at without departing from the spirit and scope of the appended claims.

Throughout this specification and the claims which follow, unless the context requires otherwise, the word “comprise”, and variations such as “comprises” or “comprising”, will be understood to imply the inclusion of a stated integer or step or group of integers or steps but not to the exclusion of any other integer or step or group of integers or steps.

1. A method of manufacture of an extruded synthetic wood structural material which comprises at least a wood fiber content, a plastic resin content, and a coloring agent, comprising the steps of:
(a) placing together finely divided wood fiber and a coloring agent;
(b) feeding said wood fiber and said coloring agent to a heated mixer to thoroughly mix said wood fiber and said coloring agent, and so as to drive water vapor away from said wood fiber;
(c) adding and thoroughly mixing said plastic resin content to said thoroughly mixed wood fiber and coloring agent, while continuing to heat the same;
(d) transferring said thoroughly mixed plastic resin, wood fiber, and coloring agent mixture to an extrusion die and forcing said mixture through said extrusion die; and
(e) cooling and hardening said extruded mixture, and cutting to lengthen the so-formed extruded synthetic wood structural material;
wherein said wood fiber content initially has a moisture content of from 0.5% to 20% by weight thereof;
wherein said extruded synthetic wood structural material is colored by said coloring agent, and has a moisture content of zero up to about 0.1% by weight thereof; and
wherein said extruded synthetic wood structural material comprises from 20% to 60% by weight of wood fiber content, from 20% to 60% by weight of plastic resin content, and from 0.5% to 5.0% by weight of coloring agent.

2. The method of claim 1, wherein said finely divided wood fiber and said coloring agent are coarsely mixed together and stored in location remote from said heated mixer.

3. The method of claim 1, wherein said finely divided wood fiber and said coloring agent are coarsely mixed together just prior to step (b), in a location adjacent said heated mixer.

4. The method of claim 1, wherein said finely divided wood fiber is wood flour.

5. The method of claim 1, wherein said heated mixer is a twin screw mixer having a heated jacket and at least one vent for said water vapor as it is driven off, and wherein said heated jacket is heated to a temperature of from 120° C. to 235° C.

6. The method of claim 1, wherein said wood fiber content is chosen from the group consisting of sawdust, finely divided wood chips, ground wood, wood meal, wood flour, finely divided wood flakes, finely divided coconut shells, finely divided peanut shells, palm fiber, bamboo fiber, rice hulls, wheat pulp, finely divided straw, and mixtures and combinations thereof.

7. The method of claim 1, wherein said plastic resin content is chosen from the group consisting of polyethylene, polypropylene, polyvinyl chloride, low-density polyethylene, ethyl-vinyl acetate, and mixtures and combinations thereof.

8. The method of claim 1, wherein said coloring agent is chosen from the group consisting of color pellets, color pigments, and mixtures and combinations thereof.

9. The method of claim 1, wherein step (d) is carried out in part by pumping said thoroughly mixed plastic resin, wood fiber, and coloring agent, through a single screw pump, so as to force said mixture through said extrusion die.

10. The method of claim 9, wherein said single screw pump has a heated jacket so as to keep said mixture in a substantially molten state.

11. The method of claim 1, wherein the formulation of said extruded synthetic wood structural material further comprises at least one additive chosen from the group consisting of a lubricant in the amount of 1% to 10% by weight, a strengthening agent in the amount of 1% to 30% by weight, a fungicide in the amount of 0.1% to 5% by weight, a UV inhibitor in the amount of 0.1% to 5% by weight, and mixtures and combinations thereof; and
wherein said at least one additive is added to the formulation between step (b) and step (c).
